(19) United States
(12) Patent Application Publication
(10) Pub. No.: US 2006/0193300 A1
(43) Pub. Date: Aug. 31, 2006

(54) Method and apparatus for monitoring multiple network segments in local area networks for compliance with wireless security policy

(75) Inventors: Jai Rawat, Sunnyvale, CA (US); Jatin Parekh, Ghatkopar (E) (IN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: AirTight Networks, Inc. (F/K/A Wibhu Technologies, Inc.), Mountain View, CA (US)

(21) Appl. No.: 11/215,405

(22) Filed: Aug. 29, 2005

Related U.S. Application Data
(60) Provisional application No. 60/610,419, filed on Sep. 16, 2004.
(60) Provisional application No. 60/676,560, filed on Apr. 28, 2005.

(51) Int. Cl. H04Q 7/24

(52) U.S. Cl. 370/338

(57) ABSTRACT

Method and system for monitoring a plurality of network segments in a local area network within a selected geographic region is provided. The monitoring is performed to check compliance with one or more wireless security policies. The method comprises providing a network monitoring device and coupling the network monitoring device to a connection port of the local are network. Moreover, the method includes providing one or more sniffers that are adapted to interact with a wireless medium. The sniffers are spatially disposed within and/or in a vicinity of the selected geographic region. The method includes determining a connectivity status of at least one wireless access device to the local area network.

### CROSS-REFERENCES TO RELATED APPLICATIONS

This present application claims priority to U.S. Provisional Application No. 60/610,419, titled “Method and system for preventing unauthorized connection of wireless access devices to local area computer networks,” filed Sep. 16, 2004, and U.S. Provisional Application No. 60/676,560, titled “Monitoring multiple network segments in local area networks for wireless security policy compliance,” filed Apr. 28, 2005; commonly assigned, and each of which is hereby incorporated by reference for all purposes.

The present invention also relates to U.S. application Ser. No. 10/931,926, filed on Aug. 31, 2004 (Attorney Docket Number 022384-000610US) and U.S. application Ser. No. 11/026,960, filed on Dec. 29, 2004 (Attorney Docket Number 022384-001300US); commonly assigned, and each of which is hereby incorporated by reference for all purposes.

### BACKGROUND OF THE INVENTION

The present invention relates generally to wireless computer networking techniques. In particular, the invention provides methods and apparatus for intrusion detection for local area networks preferably with wireless extensions. More particularly, the invention provides methods and apparatus for monitoring plurality of network segments in a local area network for wireless access devices operably coupled to them. The present intrusion detection can be applied to many computer networking environments, e.g., environments based upon the IEEE 802.11 family of standards (called WLAN or WiFi), Ultra Wide Band (UWB), IEEE 802.16 (WiMAX), Bluetooth, and others.

Computer systems have proliferated from academic and specialized science applications to day-to-day business, commerce, information distribution and home applications. Such systems can include personal computers (PCs) to large mainframe and server class computers. Powerful mainframe and server class computers run specialized applications for banks, small and large companies, e-commerce vendors; and governments. Personal computers can be found in many offices, homes, and even local coffee shops.

The computer systems located within a specific local geographic area (e.g., an office, building floor, building, home, or any other defined geographic region (indoor and/or outdoor)) are typically interconnected using a Local Area Network (LAN)(e.g., the Ethernet). The LANs, in turn, can be interconnected with each other using a Wide Area Network (WAN)(e.g., the Internet). A conventional LAN can be deployed using an Ethernet-based infrastructure comprising cables, hubs switches, and other elements.

Connection ports (e.g., Ethernet ports) can be used to couple multiple computer systems to the LAN. For example, a user can connect to the LAN by physically attaching a computing device (e.g., a laptop, desktop, or handheld computer) to one of the connection ports using physical wires or cables. Other types of computer systems, such as database computers, server computers, routers, and Internet gateways, can be connected to the LAN in a similar manner. Once physically connected to the LAN, a variety of services can be accessed (e.g., file transfer, remote login, email, WWW, database access, and voice over IP).

Using recent (and increasingly popular) wireless technologies, users can now be wirelessly connected to the computer network. Thus, wireless communication can provide wireless access to a LAN in the office, home, public hot-spot, and other geographical locations. The IEEE 802.11 family of standards (WiFi) is a common standard for such wireless communication. In WiFi, the 802.11b standard provides for wireless connectivity at speeds up to 11 Mbps in the 2.4 GHz radio frequency spectrum; the 802.11g standard provides for even faster connectivity at about 54 Mbps in the 2.4 GHz radio frequency spectrum; and the 802.11a standard provides for wireless connectivity at speeds up to 54 Mbps in the 5 GHz radio frequency spectrum.

Advantageously, WiFi can facilitate a quick and effective way of providing a wireless extension to an existing LAN. To provide this wireless extension, one or more WiFi access points (APs) can connect to the connection ports either directly or through intermediate equipment, such as WiFi switch. After an AP is connected to a connection port, a user can access the LAN using a device (called a station) equipped with WiFi radio. The station can wirelessly communicate with the AP.

In the past, security of the computer network has focused on controlling access to the physical space where the LAN connection ports are located. The application of wireless communication to computer networking can introduce additional security exposure. Specifically, the radio waves that are integral to wireless communication often cannot be contained in the physical space bounded by physical structures, such as the walls of a building.

Hence, wireless signals often “spill” outside the area of interest. Because of this spillage, unauthorized users, who could be using their stations in a nearby street, parking lot, or building, could wirelessly connect to the AP and thus gain access to the LAN. Consequently, providing conventional security by controlling physical access to the connection ports of the LAN would be inadequate.

To prevent unauthorized access to the LAN over WiFi, the AP can employ certain techniques. For example, in accordance with 802.11, a user is currently requested to carry out an authentication handshake with the AP (or a WiFi switch that resides between the AP and the existing LAN) before being able to connect to the LAN. Examples of such handshake are Wireless Equivalent Privacy (WEP) based shared key authentication, 802.1x based port access control, and 802.11i based authentication. The AP can provide additional security measures such as encryption and firewalls.

Despite these measures, security risks still exist. For example, an unauthorized AP may connect to the LAN and then, in turn, allow unauthorized users to connect to the LAN. These unauthorized users can thereby access proprietary/trade secret information on computer systems connected to the LAN without the knowledge of the owner of the LAN. Notably, even if the owner of the LAN enforces no WiFi policy (i.e., no wireless extension of the LAN allowed at all), the threat of unauthorized APs still exists.

Therefore, a need arises for a system and technique that improves security for LAN environments.

### BRIEF SUMMARY OF THE INVENTION

The present invention relates generally to wireless computer networking techniques. In particular, the invention provides methods and apparatus for intrusion detection for local area networks preferably with wireless extensions. More particularly, the invention provides methods and apparatus for monitoring plurality of network segments in a local area network for wireless access devices operably coupled to them. The present intrusion detection can be applied to many computer networking environments, e.g., environments based upon the IEEE 802.11 family of standards (called WLAN or WiFi), Ultra Wide Band (UWB), IEEE 802.16 (WiMAX), Bluetooth, and others.

The application of wireless communication to computer networking has introduced significant security risks according to certain examples. For example, the radio waves that are integral to wireless communication can “spill” outside a region within which local area computer network is operated (e.g., office space, building, etc.). Unfortunately, unauthorized wireless devices can detect the radio “spillage” of wireless access devices in the local area network and connect to the network through these wireless access devices. Additionally, unauthorized wireless access devices can surreptitiously operate within the local area network and can be connected to the local area network infrastructure. These devices can pose serious security threats to the network due to their signal spillage. Therefore, as computer networks with wireless extensions become more ubiquitous, users are increasingly concerned about unauthorized wireless access to the network. The present invention provides methods and systems for monitoring a plurality of network segments in a local area network within a selected geographic region for compliance with one or more wireless security policies, including a way for detecting wireless access devices that are connected to the network segments.

In one embodiment the method includes providing a selected geographic region (e.g. office, campus, apartment or any other indoor/outdoor region) comprising a local area network. Preferably, the local area network comprises multiple network segments (e.g. VLANs, IP subnets etc.). One or more selected network segments of the multiple network segments are to be monitored for compliance with one or more wireless security policies. Preferably, each of the selected network segments comprises at least one wired portion.

The method includes providing a network monitoring device and coupling the network monitoring device to a connection port of the local are network (e.g. connection port on a switch, a gateway, a router etc.). Preferably, the connection port is coupled to the wired portions of the selected network segments. Moreover, the method includes providing one or more sniffers that are adapted to interact with a wireless medium. The one or more sniffers are spatially disposed within and/or in a vicinity of the selected geographic region.

The method includes determining a connectivity status of at least one wireless access device to the local area network. The connectivity status is determined by correlating information associated with signals transmitted/detected on the wired portions of the selected network segments by the network monitoring device and information associated with signals transmitted/detected on the wireless medium by one or more of the sniffers. Moreover, the method includes processing at least information associated with the connectivity status of at least the one wireless access device. The method includes determining if the at least one wireless access device is in compliance with one or more of the wireless security policies for one or more of the selected network segments in the local area network.

In accordance with another aspect of the invention, a network monitoring process module is provided. The network monitoring process module is directed to monitoring a plurality of network segments in a local area network within a selected geographical region. Moreover, the network monitoring process module is directed to at least determining connectivity status of wireless access devices to the network segments. The network monitoring process module comprises one or more computer readable memories. The one or more computer readable memories comprise one or more codes. One or more of the codes is directed to generating one or more marker packets for a selected plurality of network segments in a local area network. Moreover, one or more of the codes is directed to transferring the one or more marker packets to wired portion of the selected network segments. In one embodiment, the network monitoring process module is provided within a network monitoring device. The network monitoring device can be connected into a port on a switch, a router or a gateway device in the local area network. Said port can be coupled to the wired portion of the selected network segments. In alternative embodiment, the network monitoring process module is provided within a switch, a router or a gateway device in the local area network (e.g. as a software module, firmware module, hardware module etc.).

Various other methods and systems are also provided throughout the present specification including a way for detecting wireless access devices coupled to computer local area networks.

Certain advantages and/or benefits may be achieved using the present invention. In some embodiments, the method and system are fully automated and can be used to prevent unauthorized wireless access to local area computer networks. The automated operation minimizes the human effort required during the system operation and improves the system response time and accuracy. In some embodiments, the method and system can advantageously reduce the false positives on intrusion events thereby eliminating the nuisance factor during the system operation. This is because the technique of the invention intelligently distinguishes between harmful APs and friendly neighbor's APs, the latter usually being the source of false positives.

In some embodiments, a network monitoring device or a network monitoring process module described in the invention can monitor a plurality network segments in a local area network. This eliminates the need for as many wireless sniffers as the network segments to be monitored. In other embodiments, the network monitoring device can be conveniently provided in a server room or a network operations center, while sniffers can be spatially disposed to monitor wireless activity over substantial portion of the selected geographic region comprising the local area network. In other alternative embodiments, the network monitoring process module can be conveniently provided within a switch, a router or a gateway device in the local area network. Depending upon the embodiment, one or more of these benefits may be achieved. These and other benefits will be described in more throughout the present specification and more particularly below.

### BRIEF DESCRIPTION OF THE DRAWINGS

FIG. 1 illustrates a simplified LAN architecture that can facilitate intrusion detection according to an embodiment of the present invention.

FIG. 2 illustrates an exemplary hardware diagram of a sniffer device according to an embodiment of the present invention.

FIG. 3 illustrates an exemplary security policy according to an embodiment of the present invention.

FIG. 4 illustrates a simplified method for detecting wireless access devices operably coupled to local area network according to an embodiment of the present invention.

FIG. 5 illustrates a simplified LAN architecture comprising a plurality of network segments according to an embodiment of the present invention.

FIG. 6 illustrates an exemplary hardware diagram of a network monitoring device according to an embodiment of the present invention.

FIG. 7 illustrates a simplified method for describing wireless security policies associated with multiple network segments in a local area network using a network monitoring device according to an embodiment of the present invention.

FIG. 7A shows a simplified illustration of wireless security policies associated with multiple network segments in a local area network according to an embodiment of the present invention.

FIG. 8 illustrates a simplified method for determining security policy compliance using a network monitoring device or a network monitoring process module and one or more sniffers according to an embodiment of the present invention.

FIG. 9 illustrates a simplified method for determining security policy compliance using a network monitoring device or a network monitoring process module and one or more sniffers according to another embodiment of the present invention.

FIG. 10 illustrates a simplified method for determining security policy compliance using a network monitoring device or a network monitoring process module and one or more sniffers according to yet another embodiment of the present invention.

FIG. 11 illustrates an exemplary system diagram of a network monitoring process module according to yet another embodiment of the present invention.

### DETAILED DESCRIPTION OF THE INVENTION

The present invention relates generally to wireless computer networking techniques. In particular, the invention provides methods and apparatus for intrusion detection for local area networks preferably with wireless extensions. More particularly, the invention provides methods and apparatus for monitoring plurality of network segments in a local area network for wireless access devices operably coupled to them. The present intrusion detection can be applied to many computer networking environments, e.g., environments based upon the IEEE 802.11 family of standards (called WLAN or WiFi), Ultra Wide Band (UWB), IEEE 802.16 (WiMAX), Bluetooth, and others.

Conventional security of a computer network has focused on controlling access to the physical space where the local area network (LAN) connection ports are located. The application of wireless communication to computer networking has introduced new security risks. Specifically, the radio waves that are integral to wireless communication often cannot be contained within the physical boundaries of the region of operation of a local area network (e.g., an office space or a building). This “spillage” can be detected by unauthorized wireless devices outside the region of operation. Additionally, unauthorized wireless devices can be operating within the local area network, and can even be connected to the local area network. The radio coverage of such devices that spills outside the region of operation can be used by devices outside the region to gain unauthorized access to the local area network. As computer networks with wireless extensions become more ubiquitous, users are increasingly concerned about unauthorized wireless devices, whether within or outside the region of operation of the local area network.

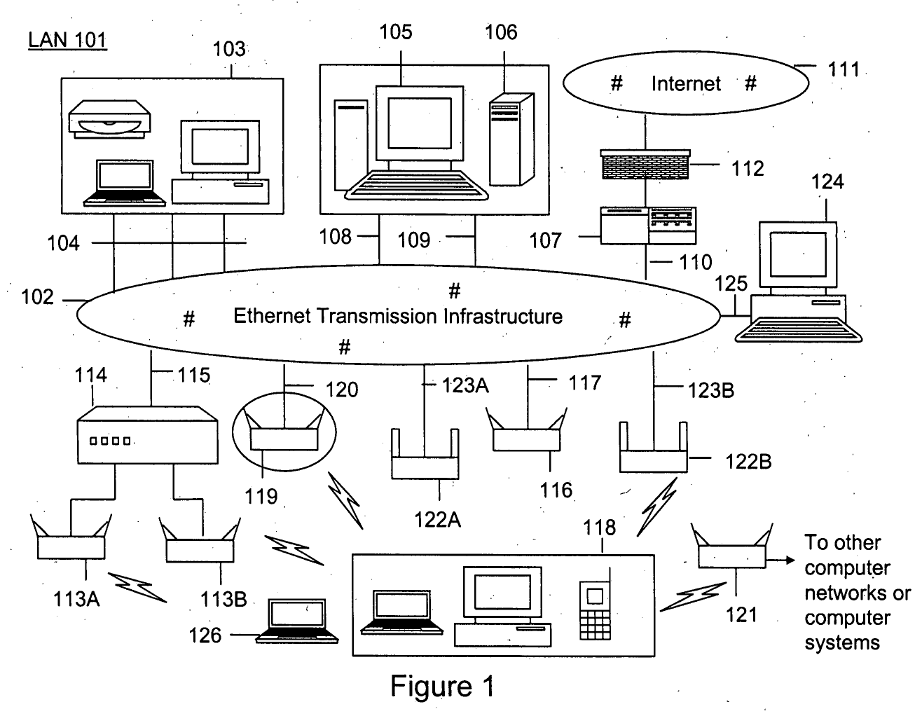

FIG. 1 illustrates a simplified local area network (LAN) 101 that can facilitate security monitoring. This diagram is merely an example, which should not unduly limit the scope of the claims herein. One of ordinary skill in the art would recognize many variations, modifications, and alternatives. In LAN 101, core transmission infrastructure 102 can include various transmission components, e.g., Ethernet cables, LAN switches and routers. In a typical deployment, the core transmission infrastructure 102 can comprise one or more network segments.

According to one embodiment, a network segment refers to an Internet Protocol or IP “subnetwork” (called “subnet”). Each subnet is identified by a network number (e.g., IP number and subnet mask) and plurality of subnets are interconnected using one or more router devices. In an alternative embodiment, a network segment can refer to a virtual local area network (VLAN) segment. In one embodiment, each VLAN can be a separate subnet.

One or more connection ports (e.g., Ethernet sockets) are provided on each of the segments for connecting various computer systems to the LAN 101. Thus, one or more end user devices 103 (such as desktop computers, notebook computers, telemetry sensors, etc.) can be connected to LAN 101 via one or more connection ports 104 using wires (e.g., Ethernet cables) or other suitable connection means. In one embodiment, one or more of the connection ports are provided using the LAN switches.

Other computer systems that provide specific functionalities and services can also be connected to LAN 101. For example, one or more database computers 105 (e.g., computers storing customer accounts, inventory, employee accounts, financial information, etc.) may be connected to LAN 101 via one or more connection ports 108. Additionally, one or more server computers 106 (computers providing services, such as database access, email storage, HTTP proxy service, DHCP service, SIP service, authentication, network management, etc.) may be connected to LAN 101 via one or more connection ports 109.

In this embodiment, a router 107 can be connected to LAN 101 via a connection port 110. Router 107 can act as a gateway between LAN 101 and the Internet 111. Note that a firewall/VPN gateway 112 can be used to connect router 107 to the Internet 111, thereby protecting computer systems in LAN 101 against hacking attacks from the Internet 111 as well as enabling remote secure access to LAN 101.

In this embodiment, a wireless extension of LAN 101 is also provided. For example, authorized APs 113A and 113B can be connected to LAN 101 via a WiFi switch 114. The WiFi switch 114 in turn can be connected to a connection port 115. The switch 114 can assist APs 113A and 113B in performing certain complex procedures (e.g., procedures for authentication, encryption, QoS, mobility, firewall, etc.) as well as provide centralized management functionality for APs 113A and 113B. Note that an authorized AP 116 can also be directly connected to LAN 101 via a connection port 117. In this case, AP 116 may perform necessary security procedures (such as authentication, encryption, firewall, etc.) itself.

In this configuration, one or more end user devices 118 (such as desktop computers, laptop computers, handheld computers, PDAs, etc.) equipped with radio communication capability can wirelessly connect to LAN 101 via authorized APs 113A, 113B, and 116. Notably, authorized APs connected to the LAN 101 provide wireless connection points on the LAN. Note that WiFi or another type of wireless network format (e.g., UWB, WiMax, Bluetooth, etc.) can be used to provide the wireless protocols.

As shown in FIG. 1, an unauthorized AP 119 can also be connected to LAN 101 using a connection port 120. Unauthorized AP 119 can be a malicious AP, an unwittingly deployed AP, a misconfigured AP, or a soft AP. A malicious AP/an unwittingly deployed AP can be an AP operated by a person having physical access to the facility and connected to LAN 101 without the permission of a network administrator. A misconfigured AP can be an AP allowable by the network administrator, but whose configuration parameters are, usually inadvertently, incorrectly configured. Note that an incorrect configuration can allow intruders to wirelessly connect to the misconfigured AP (and thus to LAN 101). A soft AP typically refers to a WiFi-enabled computer system connected to a connection port, but also functioning as an AP under the control of software. The software can be either deliberately run on the computer system or inadvertently run in the form of a virus program. Other embodiments of unauthorized APs are also possible. Notably, the unauthorized APs create unauthorized wireless connection points on the LAN.

Unauthorized AP 119 may pose any number of security risks. For example, unauthorized AP 119 may not employ the right security policies or may bypass security policy enforcing elements, e.g., switch 114. Moreover, an intruder, such as unauthorized station 126 can connect to LAN 101 and launch attacks through unauthorized AP 119 (e.g., using the radio signal spillage of the unauthorized AP outside the region of operation of the LAN).

FIG. 1 also shows another unauthorized AP 121 whose radio coverage spills into the region of operation the concerned LAN. According to a specific embodiment, the AP 121 can be an AP in the neighboring office that is connected or unconnected to the neighbor's LAN, an AP on the premises of LAN 101 that is not connected to the LAN 101 and other APs, which co-exist with the LAN and share the airspace without any significant and/or harmful interferences. According to another specific embodiment, the AP 121 can be hostile AP. Notably, even though not connected to LAN 101, unauthorized AP 121 may lure authorized stations into communicating with it, thereby compromising their security. The hostile AP may lure authorized wireless stations into connecting to it and launch man-in-the-middle, denial of service, MAC spoofing and other kinds of disruptive attacks.

In accordance with one aspect of the invention, a security monitoring system can protect LAN 101 from unauthorized access (i.e., unauthorized AP or unauthorized station). The security monitoring system can include one or more RF sensor/detection devices (e.g., sensor devices 122A and 122B, each generically referenced herein as a sniffer 122) disposed within or in a vicinity of a selected geographic region comprising at least a portion of LAN 101. In one embodiment (shown in FIG. 1), sniffer 122 can be connected to LAN 101 via a connection port (e.g., connection port 123A/123B). In another embodiment, sniffer 122 can be connected to LAN 101 using a wireless connection.

A sniffer 122 is able to monitor wireless activity in a subset of the selected geographic region. Wireless activity can include any transmission of control, management, or data packets between an AP and one or more wireless stations, or among one or more wireless stations. Wireless activity can even include communication for establishing a wireless connection between an AP and a wireless station (called “association”).

In general, sniffer 122 can listen to a radio channel and capture transmissions on that channel. In one embodiment, sniffer 122 can cycle through multiple radio channels on which wireless communication could take place. On each radio channel, sniffer 122 can wait and listen for any ongoing transmission. In one embodiment, sniffer 122 can operate on multiple radio channels simultaneously.

Whenever a transmission is detected, sniffer 122 can collect and record the relevant information about that transmission. This information can include all or a subset of information gathered from various fields in a captured packet. Other information such as the size of the packet and day and time when the transmission was detected can also be recorded.

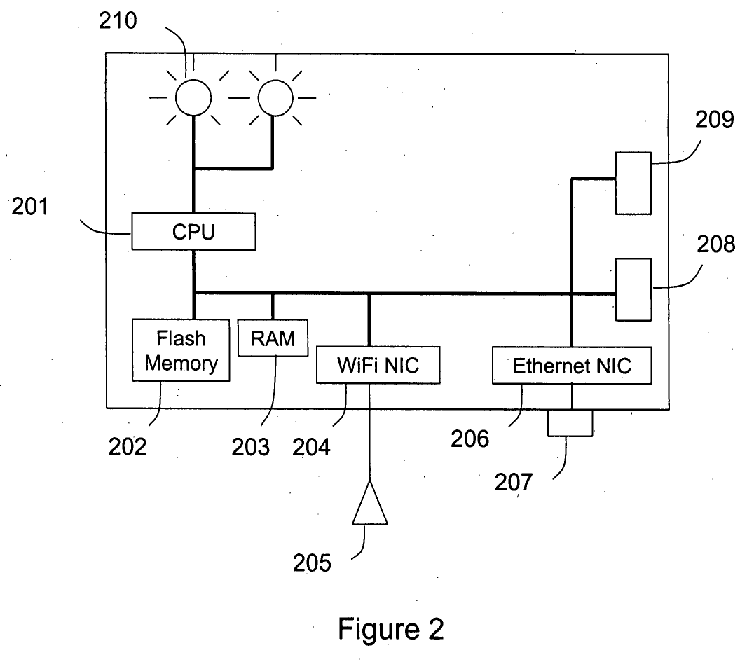

In one embodiment, sniffer 122 can be any suitable device capable of detecting wireless activity. In one embodiment, a sniffer 122 could also be provided with radio transmission functionality, which allows sniffer 122 to generate interference with a suspected intruder's transmission. The radio transmission functionality could also be used by the sniffer 122 for active probing which involves transmission of test signals. An exemplary hardware diagram of the sniffer is shown in FIG. 2. This diagram is merely an example, which should not unduly limit the scope of the claims herein. One of ordinary skill in the art would recognize many variations, alternatives, and modifications. As shown, in order to provide the desired detection/transmission functionality, sniffer 122 can have a central processing unit (CPU) 201, a flash memory 202 where the software code for sniffer functionality resides, and a RAM 203 which serves as volatile memory during program execution. The sniffer 122 can have one or more 802.11 wireless network interface cards (NICs) 204 which perform radio and wireless MAC layer functionality for wireless reception and transmission and one or more of dual-band (i.e., for reception/transmission in both the 2.4 GHz and 5 GHz radio frequency spectrums) antennas 205 coupled to the wireless NICs. Each of the wireless NICs 204 can operate in a, b, g, b/g or a/b/g mode. Moreover, the sniffer 122 can have an Ethernet NIC 206 which performs Ethernet physical and MAC layer functions (e.g. for reception and transmission of data on wired network), an Ethernet jack 207 such as RJ-45 socket coupled to the Ethernet NIC for connecting the sniffer device to wired LAN with optional power over Ethernet or POE, and a serial port 208 which can be used to flash/configure/troubleshoot the sniffer device. A power input 209 is also provided. One or more light emitting diodes (LEDs) 210 can be provided on the sniffer device to convey visual indications (such as device working properly, error condition, unauthorized wireless device alert, and so on).

In one embodiment, sniffer 122 can be built using a hardware platform similar to that used to build an AP, although having different functionality and software. In one embodiment, to more unobtrusively be incorporated in the defined geographic region, sniffer 122 could have a small form factor. In another embodiment, the sniffer functionality and the AP functionality can be provided in a single device. In yet another embodiment, sniffer functionality can be provided using appropriate software in a computer system (e.g. laptop, PDA etc.) equipped with WiFi radio. Other embodiments of sniffer device/functionality are also possible.

A sniffer 122 can be spatially disposed at an appropriate location in the selected geographic region by using heuristics, strategy, and/or calculated guesses. In accordance with one aspect of the invention, an RF (radio frequency) planning tool can be used to determine an optimal deployment location for sniffer 122.

Server 124 (also called “security appliance”) can be coupled to LAN 101 using a connection port 125. In one embodiment, each sniffer 122 can convey its information about detected wireline/wireless activity to server 124 (i.e., over one or more computer networks). Server 124 can then analyze that information, store the results of that analysis, and process the results. In another embodiment, sniffer 122 may filter and/or summarize its information before conveying it to server 124.

Sniffer 122 can also advantageously receive configuration information from server 124. This configuration information can include, for example, the operating system software code, the operation parameters (e.g., frequency spectrum and radio channels to be scanned), the types of wireless activities to be detected, and the identity information associated with any authorized wireless device. Sniffer 122 may also receive specific instructions from server 124, e.g., tuning to specific radio channel or detecting transmission of specific packet on a radio channel.

According to an aspect of the present invention, the security monitoring system can classify the APs into three categories: authorized, rogue and external. In one embodiment, an “authorized AP” refers to the AP allowed by the network administrator (e.g., APs 113A, 1133B and 116), a “rogue AP” refers to the AP not allowed by the network administrator, but still connected to the LAN to be protected (e.g., AP 119), and an “external AP” refers to the AP not allowed by the network administrator, but not connected to the LAN to be protected (e.g., AP 121). For example, the external AP can be neighbor's AP connected to neighbor's network.

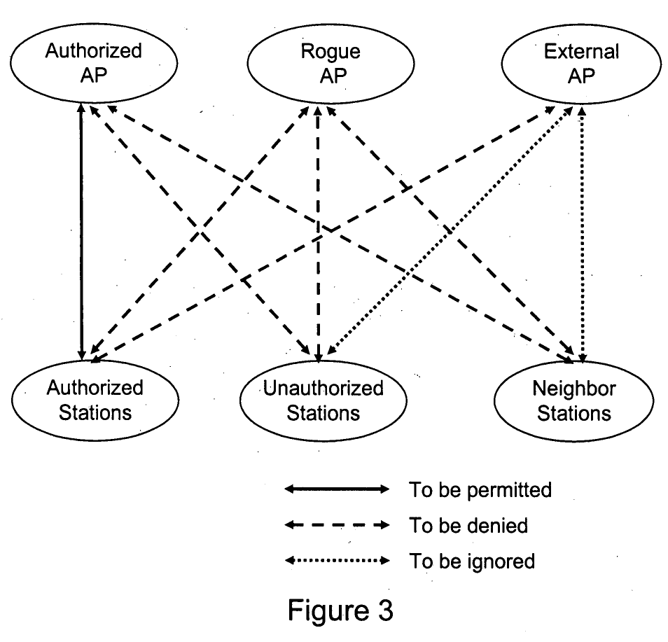

Advantageously, a security policy can be enforced using the foregoing AP classification. For example, wireless communication between an authorized wireless station (e.g., stations 118) and the authorized AP is to be permitted, according to a security policy. The wireless communication between an unauthorized/neighbor's wireless station (e.g., station 126) and the external AP is to be ignored, according to a security policy. Advantageously, the ignoring eliminates false alarms regarding security policy violation and removes nuisance factor from the operation of the intrusion detection system. All other wireless communication (e.g., between an authorized/unauthorized/neighbor's wireless station and the rogue AP, between an authorized wireless station and the external AP, etc.) is to be denied, according to a security policy of an embodiment in the present invention. Advantageously, the denying helps protect the integrity of the LAN and the authorized wireless stations. The aforementioned security policy is illustrated in FIG. 3. This diagram is merely an example, which should not unduly limit the scope of the claims herein. One of ordinary skill in the art would recognize many variations, modifications, and alternatives.

In one embodiment, the invention provides a method for determining if an AP is operably coupled (e.g. connected) to the LAN. This can facilitate the foregoing AP classification. The method includes correlating the traffic over the wired portion of the LAN and the traffic over wireless portion of the LAN to detect if an AP is operably coupled to the LAN. For example, an AP may forward certain packets from the wired portion to the wireless portion and vice versa. These packets can be used to infer that the AP is operably coupled to the LAN.

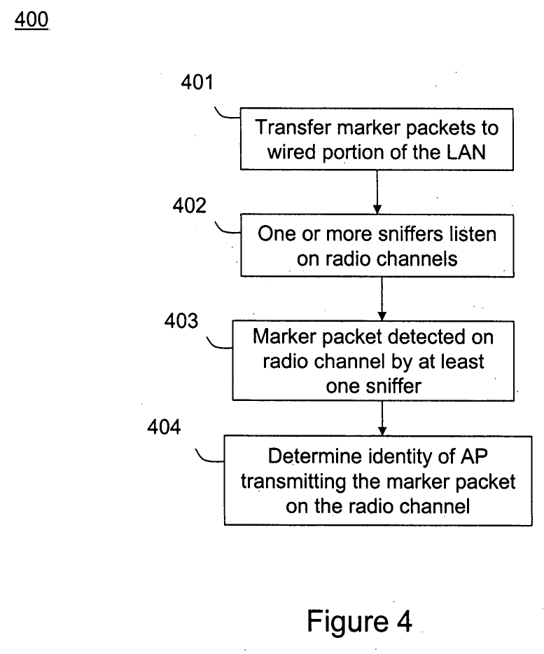

Certain specific embodiment 400 of the method to detect if an AP is operably coupled to the LAN is illustrated in FIG. 4. This diagram is merely an example, which should not unduly limit the scope of the claims herein. One of ordinary skill in the art would recognize many variations, modifications, and alternatives where one or more steps can be added, removed or interchanged. As shown in step 401, one or more packets with a selected format (called marker packets) are transferred to the wired portion of the LAN by an originator device. The originator device can transfer the marker packets through its Ethernet port. The marker packet has a selected format (e.g. length, bit pattern, values of certain packet fields etc.) using which it can later be identified by the intrusion detection system. The format can be different for different marker packets. The marker packet may contain identity of the originator device. The marker packet is received by all or a subset of APs connected to the wired portion of the LAN and transmitted by all or a subset of them on the wireless medium.

In step 402, one or more sniffers listen to one or more radio channels on which wireless communication can take place.

In step 403, preferably at least one sniffer detects the transmission of at least one marker packet on the radio channel. The marker packet is identified by analyzing the format of the captured packet.

In step 404, identity of the AP that transmits the marker packet is determined from the 802.11 MAC header (for example from the transmitter address or BSSID fields) of the packet transmitted on the radio channel. This AP can be inferred to be connected to the LAN.

In one preferred embodiment of method 400, the marker packet is an Ethernet frame addressed to the broadcast address, i.e., the value of hexadecimal FF:FF:FF:FF:FF:FF in the destination address field of the Ethernet frame header. The source address field of the Ethernet frame header is set equal to the wired side MAC address of the originator device. This packet will be received by all APs that are connected in the same LAN broadcast domain as the originator device. The APs among these acting as layer 2 bridges then transmit this broadcast packet on the wireless medium after translating it to the 802.11 style packet. The marker packet can be identified on the wireless medium from the source MAC address in it which is that of the originator device.

In an alternative embodiment, the marker packet is an Ethernet frame addressed to the MAC address of a wireless station associated with an AP. This MAC address is inferred by analyzing the prior communication between the wireless station and the AP that is captured by one or more sniffers. The source address field of the Ethernet frame header is set equal to the wired side MAC address of the originator device. This packet will be received by the AP if it is connected to the LAN. The AP acting as layer 2 bridge then transmits the marker packet on the wireless medium after translating it to the 802.11 style packet. The marker packet can be identified on the wireless medium from the source MAC address in it which is that of the originator device.

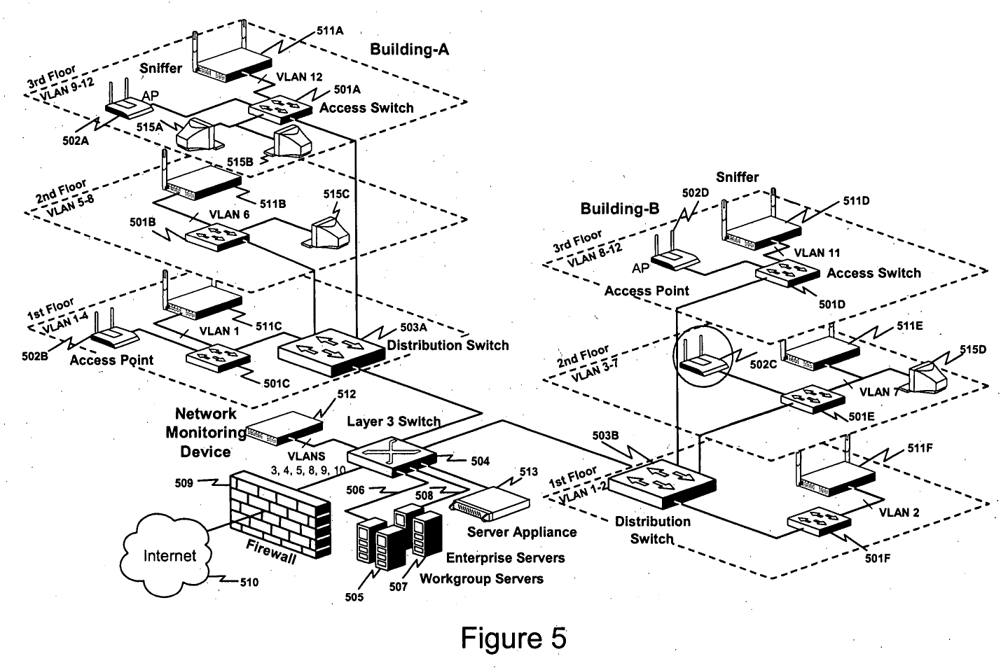

In one embodiment, a sniffer can also act as the originator device. That is, the sniffer can transfer marker packets to the network segment (e.g. VLAN or subnet) of the LAN to which it is connected using its Ethernet port. Notably, these marker packets can be received by those APs which are also connected to the same network segment. The problem often arises that there are more network segments in the LAN than the number of sniffers required to cover the selected geographic region (e.g. based on radio coverage of sniffers). Another problem often encountered is that the connection drop for a given network segment may not be available at a location where the sniffer is deployed. Some of these are illustrated in FIG. 5. This diagram is merely an example, which should not unduly limit the scope of the claims herein. One of ordinary skill in the art would recognize many variations, modifications, and alternatives.

As shown in FIG. 5, the selected geographic region comprises buildings of an organization and their vicinity. Each building can have one or more floors. As shown the local area network infrastructure of this organization can comprise one or more access switches 501A-F (e.g. Layer 2 switches), one or more distribution switches 503A, 503B (e.g. Layer 2 switches) and one or more backbone switches 504 (e.g. Layer 3 switch). Plurality of connection ports (e.g. Ethernet ports) are provided on the access switches and the distribution switches, using which computers (e.g. 515A-D) can be connected to the LAN. The wireless APs (e.g. authorized APs 502A, 502B and 502D, rogue APs 502C etc.) can also be connected into one or more of these connection ports in order to provide wireless extension of the LAN. The backbone switch 504 can also function as a router (often called Layer 3 switch). It provides connection to the Internet 510 through the firewall 509. Preferably, various servers (e.g. workgroup servers 505, enterprise servers 507 etc.) are connected into the backbone switch 504.

One or more sniffers (e.g. 511A-F) can be spatially disposed within or in the vicinity of the buildings for monitoring wireless activity according to embodiment of the present invention. Preferably, the radio coverage of sniffers substantially covers the region associated with the floors of the buildings and their vicinity so that wireless activity within the region can be monitored. The sniffers can be connected into the LAN connection ports on the access switches or distribution switches. As merely an example, the server 513 of the intrusion detection system according to embodiment of present invention can be connected into the backbone switch 504. In alternative embodiments, the server 513 can also be connected into the access switch or the distribution switch.

As shown, the LAN is partitioned into plurality of VLANs. Each of the VLANs spans one or more access/distribution/backbone switches. A connection port on a switch (e.g. access, distribution or backbone) can be configured to be a part of selected VLAN. Preferably, the computer system connected to that connection port then becomes a member of the selected VLAN. A connection port on the switch can also be configured to be a part of multiple VLANs (often called “trunking”). Such ports are preferably used for interconnection of switches (e.g. access, distribution and backbone switches). The use of trunking allows different VLANs to span multiple switches in the LAN. Packets transmitted out of the trunking port include VLAN tags (e.g. ISL/Inter Switch Link tags, IEEE 802.1Q tags etc.). The VLAN tag in the packet enables the downstream switch to determine as to which VLAN the packet belongs to so that the downstream switch can forward it to its corresponding connection ports.

Partitioning the local area network into plurality of VLANs can provide administrative convenience and performance improvement. For example, computers in one department (e.g. sales) can be a part of one VLAN, while those in another department (e.g. research) can be part of another VLAN. For example, in FIG. 5, the VLAN#4 can be the VLAN of the sales department. As merely an example, the sales department offices can be on the 1st floor of Building-A and on the 2nd floor of Building-B. Accordingly, connection ports are provided for VLAN#4 on these floors. As merely an example, the workgroup servers of sales department (e.g. servers 505) can be connected into the backbone switch port (e.g. port 506) that is configured to be the part of VLAN#4. Preferably, a separate VLAN is formed for certain other enterprise servers 507 (e.g. authentication server, DHCP server, DNS server) and intrusion detection system server 513.

Another advantage of such network partitioning is that the VLAN also limits the scope of broadcast/multicast traffic (for example, Ethernet broadcast/multicast traffic such as ARP traffic). That is, Ethernet broadcast/multicast traffic sent out by a computer connected to a given VLAN is only forwarded to computers connected to the same VLAN. This helps avoiding the flood of broadcast/multicast traffic in the local area network. The traffic from one VLAN to another (e.g. from sales VLAN to research VLAN, from sales VLAN to server VLAN etc.) can be routed through (e.g. using layer 3 or IP level forwarding) backbone switch 504.

As shown, the sniffer 511A is connected into a switch port that belongs to VLAN#12. In one embodiment, this could be because the connection drop of VLAN#12 is conveniently located in the vicinity of the location where sniffer 511A is deployed. The sniffer 511A can thus transfer marker packets into VLAN#12. The APs in the LAN that are connected to the VLAN#12 can output these marker packets on the wireless medium. One or more of the sniffers 511A-F that are in the vicinity of these APs can then detect these marker packets on the wireless medium. Similarly, sniffer 511B is connected into a switch port that belongs to VLAN#6 and hence it can transfer marker packets into that VLAN, sniffer 511D is connected into a switch port that belongs to VLAN#2 and so on. In alternative embodiment, multiple sniffers can be connected into the same VLAN (not shown in FIG. 5). All or a subset of them can then transfer marker packets in the VLAN.

Notably as shown in FIG. 5, no sniffer can be connected into the VLANs# 3, 4, 5, 8, 9, 10 (e.g. because there are less number of sniffers than the VLANs, the connection drops of these VLANs are not conveniently located near the sniffers etc.). The present invention overcomes such limitation by providing a network monitoring device 512 that can monitor such VLANs as well.

The network monitoring device 512 can be connected into a switch port (e.g. using Ethernet connection) that belongs to VLANs#3, 4, 5, 8, 9 and 10. The switch port can be on access switch, distribution switch or backbone switch as long as it can be configured to belong to desired VLANs. (e.g. can be configured to be trunking port for VLANs#3, 4, 5, 8, 9, 10). The network monitoring device can then transfer marker packets to each of these VLANs through its Ethernet connection. Preferably, a different format is used for marker packets transferred in each of the VLANs. In one embodiment, the device uses a different source MAC address in the Ethernet frame of the marker packet for each of the VLANs. Preferably, the marker packet transferred to a given VLAN includes corresponding VLAN tag (e.g. ISL or 802.1Q tag) in it, so that the packet can be propagated to switch ports belonging to the given VLAN.

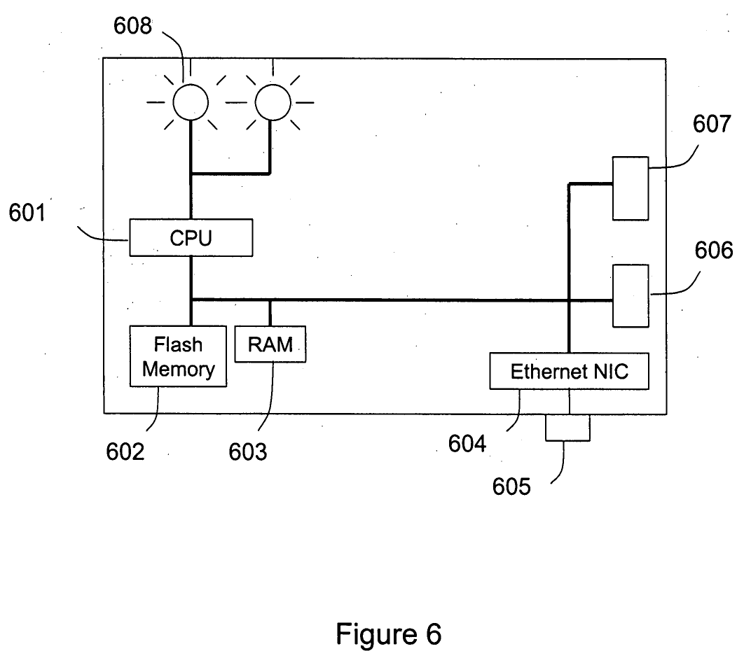

An exemplary hardware diagram of the network monitoring device is shown in FIG. 6. This diagram is merely an example, which should not unduly limit the scope of the claims herein. One of ordinary skill in the art would recognize many variations, alternatives, and modifications. As shown, in order to provide the desired network monitoring functionality, the network monitoring device 512 can have a central processing unit (CPU) 601, a flash memory 602 where the software code for network monitoring functionality resides, and a RAM 603 which serves as volatile memory during program execution. The network monitoring device 512 can have an Ethernet NIC 604 which performs Ethernet physical and MAC layer functions (e.g. for reception and transmission of data on wired network), an Ethernet jack 605 such as RJ-45 socket coupled to the Ethernet NIC for connecting the device into the switch port with optional power over Ethernet or POE, and a serial port 606 which can be used to flash/configure/troubleshoot the device. A power input 607 is also provided. One or more light emitting diodes (LEDs) 608 can be provided on the device to convey visual indications (such as device working properly, error condition, unauthorized wireless device alert, and so on).

In one embodiment, the sniffer functionality and the network monitoring device functionality can be provided within the same device. The device can function as sniffer or as network monitoring device based on the chosen configuration (e.g. via hardware switch, software command etc.). In an alternative embodiment, the network monitoring device can also simultaneously function as sniffer.

In yet an alternative embodiment, the network monitoring device functionality can be provided as software or firmware module, e.g. network monitoring process module. The network monitoring process module can be provided within the network node (e.g. Layer 2 switch, Layer 3 switch, router etc.) itself.

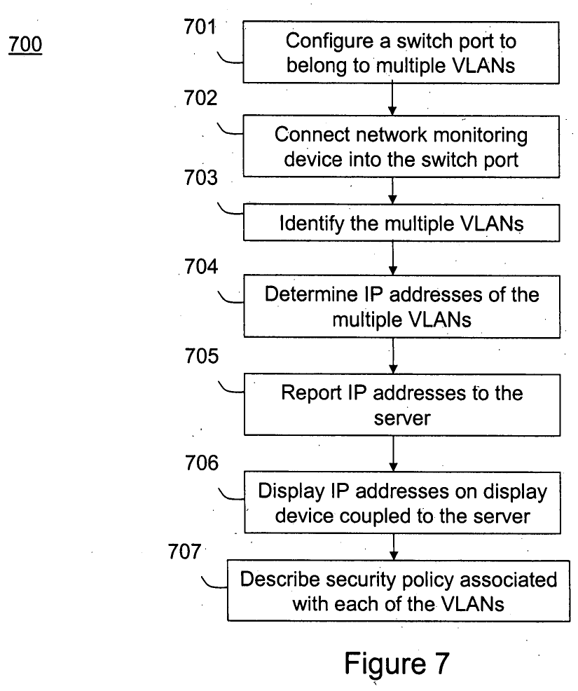

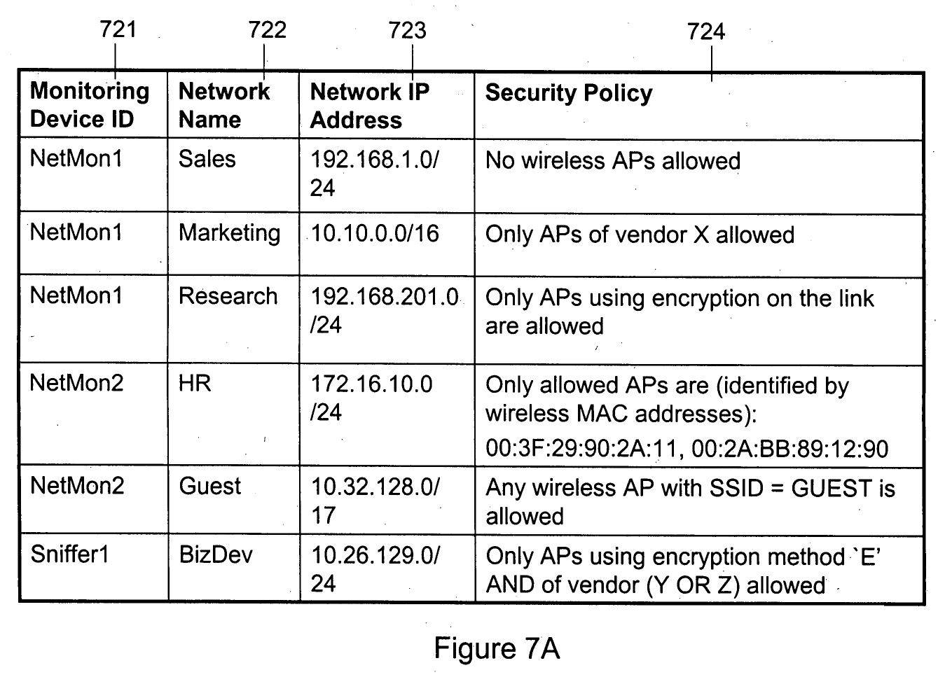

A simplified method 700 for describing security policies associated with multiple network segments in the LAN using a network monitoring device or a network monitoring process module according to an embodiment of the present invention is illustrated in FIG. 7. This diagram is merely an example, which should not unduly limit the scope of the claims herein. One of ordinary skill in the art would recognize many variations, modifications, and alternatives where one or more steps can be added, removed or interchanged. As shown, at step 701 a connection port on a LAN switch (e.g. switch 504) is configured to belong to multiple VLANs. Preferably, this is done by logging into the switch and using appropriate commands to configure the switch port. Alternatively, the configuration can be done using network management tools (e.g. SNMP/Simple Network Management Protocol). Step 702 can connect the network monitoring device into the connection port on the switch.

At step 703, the network monitoring device can determine identities of the VLANs configured with the connection port on the switch. In a preferred embodiment, the device receives broadcast and/or multicast traffic through the connection port and processes this traffic to determine VLAN identities. The VLAN to which any received broadcast and/or multicast packet belongs can be determined from the VLAN tag in the Ethernet frame header.

In an alternative embodiment, a network monitoring process module is provided in a LAN switch (e.g. as a software module, as a firmware module and so on). The network monitoring process is executed within the LAN switch. Input is provided to this process regarding the identities of the VLANs it needs to monitor. In an alternative embodiment, the monitoring process receives and analyses the packets arriving at the LAN switch through various ports and determines identities of the VLANs that it can monitor. In yet another embodiment, the monitoring process module can determine the identities of the VLANs that it can monitor from the configuration settings of the ports on the LAN switch.

The monitoring device or the monitoring process can then determine IP address of each of the discovered VLANs as shown in step 704 (e.g. using DHCP (Dynamic Host Configuration Protocol) or via other methods). In an alternative embodiment, the VLAN identities and the corresponding IP addresses can be configured into the network monitoring device or the process module. The network monitoring device 512 (or network monitoring process module) can report the information associated with the discovered (or configured) VLANs (e.g. tags, IP addresses etc.) to the server 513 as shown in step 705. This information can be displayed at step 706 on a display device (not shown in FIG. 5) coupled to the server 513. Step 707 can determine security policy associated with each of these VLANs. In one embodiment, the user provides security policy information associated with each of the displayed network segment identity (e.g. using graphical user interface, text input, radio buttons, icons, pull down menus etc.)

As exemplary security policy is illustrated in FIG. 7A. This diagram is merely an example, which should not unduly limit the scope of the claims herein. One of ordinary skill in the art would recognize many variations, modifications, and alternatives. Hereinafter the network monitoring device or the network monitoring process module are generically referred as network monitoring device. The column 721 shows identity information of the network monitoring device or the sniffer that is connected to a selected network segment. For example, as shown in FIG. 7A, there are two network monitoring devices (with identities NetMon1 and NetMon2) in use. It also shows that one of the network segments (e.g. BizDev) is being monitored by the sniffer (e.g. Sniffer1). Depending upon the embodiment, the identity information can be IP address of the network monitoring device/sniffer, manufacturer assigned identity, MAC address, user-friendly name etc. In one embodiment (shown in FIG. 7A), multiple network monitoring devices can be connected into multiple selected LAN switches or multiple selected connection ports of a single LAN switch.

The column 723 shows IP address of a selected network segment. The user can provide a user-friendly name to each of the network segments as shown in column 722. As shown in column 724, the user can specify the security policy associated with each network segment. For example as shown in FIG. 7A, the user has specified that no wireless APs are allowed to be connected to the sales network. As another example shown in FIG. 7A, the user has specified that only the APs using encryption on the wireless link are allowed to be connected to the research network. In alternative embodiment, one or more specific allowed encryption techniques can also be specified (e.g. one or more of WEP, TKIP, CCMP, IPSec etc.). As yet another example shown in FIG. 7A, the user has specified that as long as the AP uses specific encryption technique (‘E’) and is either from vendor Y or Z, it is allowed to be connected to the BizDev network segments. Many other embodiments of the security policy including, but not limited to, various ‘AND’ and ‘OR’ combinations of one or more vendors, one or more encryption techniques, one or more authentication techniques (e.g. 802.1x, shared key authentication, PSK etc.), one or more protocols (802.11b only, 802.11g only, 802.11a only, 802.11b/g, 802.11a/b/g), one or more SSIDs, one or more devices identities (e.g. MAC addresses) and other parameters are possible.

Once the security policy is described, the intrusion detection system comprising one or more sniffers 511A-F, one or more servers 513 and one or more network monitoring devices 512 can enforce this security policy. The sniffers can detect wireless activity in their vicinity and collect information associated with APs within or in the vicinity of the selected geographic region. In one embodiment, this information is reported to the server 513. In one embodiment, the information includes but not limited to MAC address of AP, SSID, use of encryption on wireless link, radio channel of operation, protocol, identities of the connected stations etc. This information can be used to enforce the security policy (e.g. as illustrated in FIG. 7A) once the intrusion detection system knows the identity of the network segment to which the AP is connected.

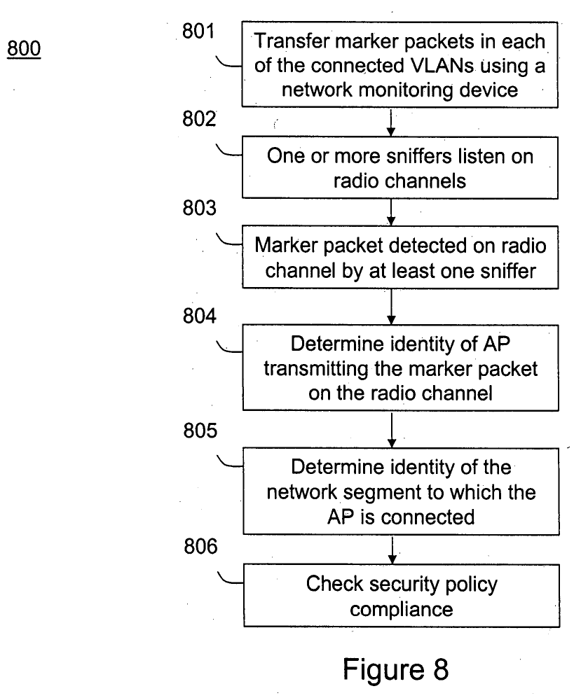

A simplified method 800 according to an embodiment of the present invention for determining security policy compliance using a network monitoring device and one or more sniffers is illustrated in FIG. 8. This diagram is merely an example, which should not unduly limit the scope of the claims herein. One of ordinary skill in the art would recognize many variations, modifications, and alternatives where one or more steps can be added, removed or interchanged. As shown (step 801), one or more marker packets are transferred by a network monitoring device to each of the VLANs it is connected to. Preferably, a distinguishable one or more formats are used for marker packets transferred to each VLAN. In one embodiment, the network monitoring device uses a MAC address from a set of one or more MAC addresses as source MAC address in the Ethernet frame header of the marker packet. Preferably the sets of MAC addresses for different VLANs are non-overlapping. In another embodiment, different one or more packet sizes are used for marker packets transferred to different VLANs. In yet another embodiment, different bit patterns are used for marker packets transferred to different VLANs. Other embodiments of packet formats are also possible. In one embodiment, the destination MAC address in the Ethernet frame is broadcast address (e.g. hexadecimal FF:FF:FF:FF:FF:FF). In an alternative embodiment, the destination MAC address in the Ethernet frame is unicast address.

The marker packets transferred in any VLAN are propagated to the APs connected to that VLAN (e.g. through one or more intermediate switches and other network nodes). At least a subset of these APs can then forward the marker packets on the wireless medium. As shown in step 802, one or more sniffers listen on radio channels. Each of the sniffers captures packets transmitted on radio channels and processes these packets to identify the marker packet format. Preferably, at least one sniffer detects at least one marker packet on a radio channel at step 803.

When the marker packet is detected on the radio channel by the sniffer, the sniffer determines the identity (e.g. MAC address) of the AP that transmits the marker packet on the wireless medium (step 804). For example, the identity can be found in the IEEE 802.11 header of the marker packet. Based on the format information associated with the marker packet, the network segment (e.g. VLAN) to which the AP is connected can be determined (step 805).

The intrusion detection system can then check the security policy compliance for the network segment as shown in step 806. For example, if the AP is found connected to the sales network, it can be deemed as violation of the security policy for sales network (e.g. in accordance with FIG. 7A). As another example, if the AP is found connected to the research network and is found to use encryption on the wireless link (e.g. as determined by the sniffers by observing wireless communication of this AP), it can be deemed as security policy compliant for that network (e.g. in accordance with FIG. 7A). On the other hand, if the AP is found not to use encryption, it can be deemed as security policy violation of the research network.

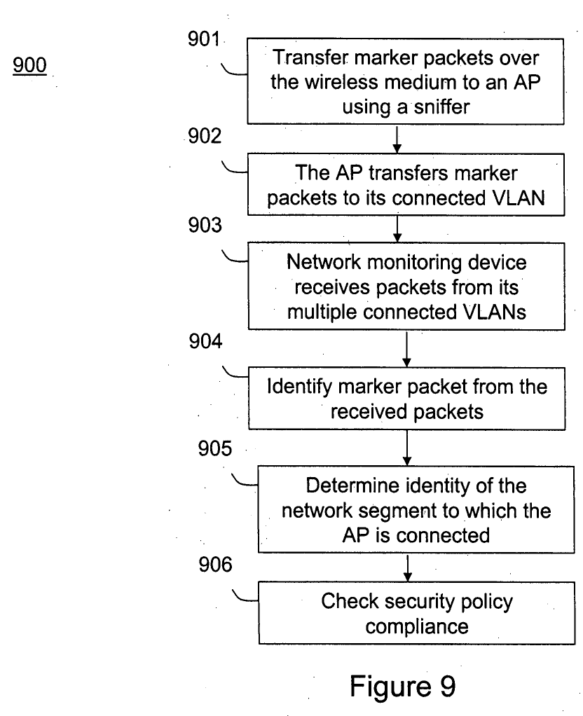

A simplified method 900 according to an embodiment of the present invention for determining security policy compliance using a network monitoring device and one or more sniffers is illustrated in FIG. 9. This diagram is merely an example, which should not unduly limit the scope of the claims herein. One of ordinary skill in the art would recognize many variations, modifications, and alternatives where one or more steps can be added, removed or interchanged. As shown (step 901), one or more marker packets are transferred by a sniffer to an AP over the wireless medium. Preferably, a distinguishable one or more formats are used for marker packets. In one embodiment, the sniffer uses address (e.g. MAC address, IP address etc.) of a client station associated with the AP as source address in the marker packet (e.g. the sniffer spoofs the source address of the client). In one embodiment, the sniffer includes information associated with the AP (e.g. AP's wireless side MAC address, SSID, use of encryption on wireless link, identities of client stations connected to AP, uptime of the AP, downtime of the AP etc.) in the marker packet. The sniffer can also include its own identity in the marker packet. In one embodiment, the marker packet is addressed to a selected multicast address (e.g. the IP multicast address that is known to the intrusion detection system). In alternative embodiment, the marker packet is addressed to a broadcast address (e.g. IP or Ethernet broadcast address).

The AP receives marker packet over the wireless link and then forwards it to its connected network segment (VLAN) at step 902. The network monitoring device is connected to multiple VLANs and it receives packets from those VLANs (e.g. at least multicast and broadcast packets) as shown in step 903. The network monitoring device processes the received packets (step 904) to identify marker packets. When the marker packet is identified, the identify of the VLAN over which it was received is determined at step 905 (e.g. using the VLAN tag present in the Ethernet frame header of the marker packet). This provides information about the VLAN to which the AP that forwards the marker packet is connected. Once this is determined, the intrusion detection system can check the security policy compliance for the network segment as shown in step 906 (similar to step 806).

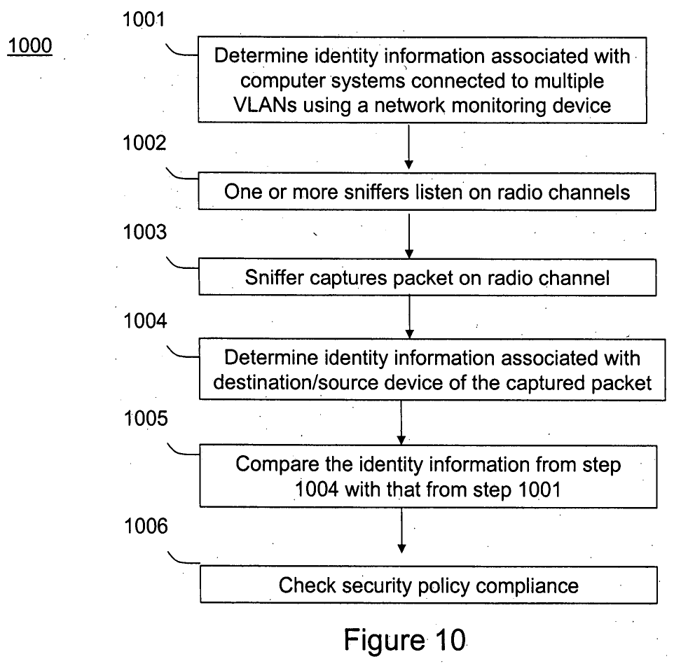

A simplified method 1000 according to an embodiment of the present invention for determining security policy compliance using a network monitoring device and one or more sniffers is illustrated in FIG. 10. This diagram is merely an example, which should not unduly limit the scope of the claims herein. One of ordinary skill in the art would recognize many variations, modifications, and alternatives where one or more steps can be added, removed or interchanged.

At step 1001, identity information associated with at least a subset of computer systems connected to multiple network segments (e.g. VLANs, subnets etc.) can be determined using a network monitoring device. In one embodiment, the identity information comprises MAC addresses (e.g. wired side MAC addresses) of the computer systems. In another embodiment, the identity information comprises IP addresses of the computer systems. In one embodiment, the network monitoring device receives and processes ARP (address resolution protocol) traffic from a network segment to which it is connected to determine the identity information of the connected computer systems. In another embodiment, the network monitoring device can perform scanning (e.g. using network scanning tools such as ‘ettercap’, sending ARP requests to one or more IP addresses in the subnet, sending broadcast ping, sending ping to selected multicast addresses etc.) on a network segment to determine the identity information of the connected computer systems. In one embodiment, the identity information is reported to the server 513.

As shown in step 1002, one or more sniffers can listen on radio channels. The sniffer captures and processes packets transmitted on the radio channels (step 1003). In one embodiment, the sniffer determines identity of a computer system that is destination/source of the captured packet (step 1004). In one embodiment, the packet is transmitted to an AP on wireless link (e.g. by a client wireless station). In this embodiment, the identity information is derived from destination device information in the packet (e.g. ultimate destination with AP acting as relay). For example, in an 802.11 packet transmitted to the AP by the client wireless station, the transmitter address is the MAC address of the client station, the receiver address is the MAC address of the AP and the destination address is the MAC address of the computer system in the LAN to which the packet is ultimately destined to. In another embodiment, the packet is transmitted from the AP on wireless link (e.g. to the client wireless station). In this embodiment, the identity information is derived from source device information in the packet (e.g. ultimate source with AP acting as relay).

At step 1005, in one embodiment the identity information from step 1004 is compared with the identity information from step 1001. If a match is found, the AP can be inferred to the connected to the network segment corresponding to the identity information. The intrusion detection system can then check the security policy compliance for the network segment as shown in step 1006.

In one alternative embodiment, at step 1004 the sniffer determines a wireless side MAC address of an access device. At step 1005, the wireless side MAC address is compared with the MAC addresses of the computer systems determined in step 1001 to determine if the list of MAC addresses from step 1001 contains a MAC address that is numerically close to the wireless side MAC address of the access device. If such MAC address is found, the wireless access device can be inferred to be connected to the network segment corresponding to said MAC address. This is because, wireless and wire side MAC addresses of a number of wireless access devices are often numerically close to each other. As merely an example, the wireside MAC address of an access device can be within plus or minus a small number (e.g. 3) of the wireless side MAC address.

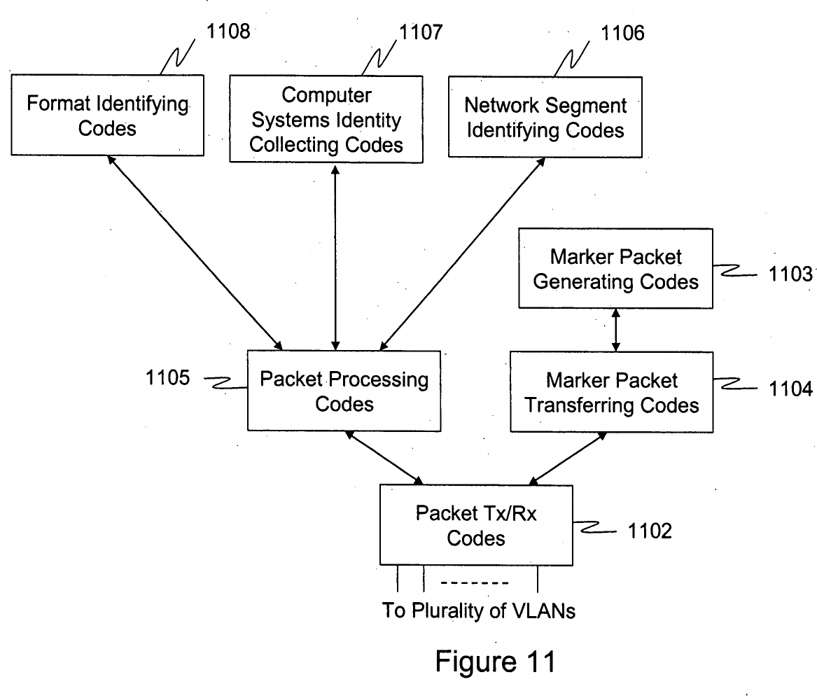

FIG. 11 illustrates an exemplary system diagram of a network monitoring process module according to yet another embodiment of the present invention. This diagram is merely an example, which should not unduly limit the scope of the claims herein. One of ordinary skill in the art would recognize many variations, modifications, and alternatives. In one embodiment, the network monitoring process module is provided within a network monitoring device and the network monitoring device is connected into a port on a switch, a gateway or a router device in the local area network. In an alternative embodiment, the network monitoring process module is provided within a switch, a gateway or a router device in the local area network.

As shown the network monitoring process module comprises one or more packet transmitting/receiving codes (1102). The codes 1102 are directed to transmit and receive packets to and from a plurality of VLANs in the local area network. The network monitoring process module comprises one or more marker packet generating codes (1103). The codes 1103 are directed to generate one or more marker packets for each of the plurality of VLANs. Preferably, the maker packets for a selected VLAN have one or more selected format. One or more codes (1104) are directed to transferring the marker packets to the VLANs. In one embodiment, the marker packet transferring code includes a selected VLAN tag in the marker packets that are to be transferred to the selected VLAN.

The network monitoring process module comprises one or more packet processing codes (1105). The codes 1105 are directed to processing information associated with packets received form the plurality of VLANs. One or more network segment identifying codes (1106) are directed to identify VLAN identities. In one embodiment, the packet processing codes 1105 extract VLAN tags from the received packets and provide information associated with the tags to the network segment identifying codes 1106. The VLAN tags can comprise VLAN identities. The codes 1106 can then execute DHCP protocol to discover IP addresses associated with these VLAN identities.

One or more computer system identity collecting codes (1107) are directed to identify at least a subset of computer systems connected to each of the plurality of network segments. In one embodiment, the packet processing codes 1105 process the received packets to identify ARP packets and transfer information associated with them to the computer system identity collecting codes 1107. The codes 1107 can then derive identity information (e.g. MAC addresses) of computer systems that are connected to each of the plurality of VLANs. In one embodiment, the codes 1107 process ARP request packet and derive MAC address information about the source of the packet. In an alternative embodiment, the codes 1107 process ARP response packet and derive MAC address information about the source of the packet.

The network monitoring process module comprises one or more format identifying codes 1108. The codes 1168 are directed to identifying one or more selected format in the received packet to identify marker packets originated by the sniffer devices. Moreover, the codes 1108 are directed to identifying the VLAN from which a packet having the selected format is received. The codes 1108 are also directed to identify information associated with a wireless access device provided in the packet by the sniffer device (e.g. wireless MAC address, SSID etc.). Moreover the codes 1108 are directed to identify wire side identities (e.g. wire side MAC address, wire side IP address) of the wireless access device from information provided in headers of the packet.

The various embodiments of the present invention may be implemented as part of a computer system. The computer system may include a computer, an input device, a display unit, and an interface, for example, for accessing the Internet. The computer may include a microprocessor. The microprocessor may be connected to a data bus. The computer may also include a memory. The memory may include Random Access Memory (RAM) and Read Only Memory (ROM). The computer system may further include a storage device, which may be a hard disk drive or a removable storage drive such as a floppy disk drive, optical disk drive, jump drive and the like. The storage device can also be other similar means for loading computer programs or other instructions into the computer system.

As used herein, the term ‘computer’ may include any processor-based or microprocessor-based system including systems using microcontrollers, digital signal processors (DSP), reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term ‘computer’. The computer system executes a set of instructions that are stored in one or more storage elements, in order to process input data. The storage elements may also hold data or other information as desired or needed. The storage element may be in the form of an information source or a physical memory element within the processing machine.

The set of instructions may include various commands that instruct the processing machine to perform specific operations such as the processes of the various embodiments of the invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms ‘software’ and ‘firmware’ are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. Method for monitoring a plurality of network segments in a local area network within a selected geographic region for compliance with one or more wireless security policies, the method comprising:
providing a selected geographic region comprising a local area network, the local area network comprising multiple network segments, one or more selected network segments of the multiple network segments to be monitored for compliance with one or more wireless security policies, each of the selected network segments comprising at least one wired portion;
providing a network monitoring device, the network monitoring device being coupled to a connection port of the local are network, the connection port being coupled to the wired portions of the selected network segments;
providing one or more sniffers, the sniffers being adapted to interact with a wireless medium and spatially disposed within and/or in a vicinity of the selected geographic region;
determining a connectivity status of at least one wireless access device to the local area network, the connectivity status being determined by correlating information associated with signals provided on the wired portions of the selected network segments by the network monitoring device and information associated with signals provided on the wireless medium by one or more of the sniffers;
processing at least information associated with the connectivity status of at least the one wireless access device; and
determining if the at least one wireless access device is in compliance with one or more of the wireless security policies for one or more of the selected network segments in the local area network.

2. The method of claim 1 wherein the connectivity status identifies which one or more of the selected network segments the wireless access device is connected to.

3. The method of claim 1 wherein the connectivity status identifies which one or more of the selected network segments the wireless access device is unconnected to.

4. The method of claim 1 wherein the one or more wireless security policies is selected from:
a. no wireless access devices connected to a network segment; and
b. only wireless access devices relating to a predetermined characteristic allowed on a network segment.

5. The method of claim 4 wherein the predetermined characteristic corresponds to one or more parameters selected from a group consisting of one or more vendor names, one or more encryption techniques, one or more device identities, one or more radio channels of operation, one or more protocols and one or more SSIDs.

6. The method of claim 5 wherein the one or more parameters comprise one or more device identities.

7. The method of claim 5 wherein the one or more parameters comprise one or more SSIDs and one or more encryption techniques.

8. The method of claim 1 wherein the one or more sniffers are spatially distributed to monitor substantial portion of the selected geographic region.

9. The method of claim 1 wherein the network monitoring device is provided in a server room or a network operations center.

10. The method of claim 1 wherein the network monitoring device is connected into a connection port of a switch, a router or a gateway, the connection port being configured to couple to the wired portions of the selected network segments.

11. The method of claim 1 wherein the network monitoring device is provided within a switch, a router or a gateway device as one or more software process modules.

12. The method of claim 1 wherein the multiple network segments are provided using VLANs.

13. The method of claim 1 wherein the network monitoring device further comprises wireless interface device, the wireless interface device being adapted to interact with a wireless medium.

14. The method of claim 1 wherein the determining the connectivity status comprises transferring one or more marker packets to the wired portions of the selected network segments using the network monitoring device.

15. The method of claim 1 wherein the determining the connectivity status comprises receiving and processing one or more packets from the wired portions of the selected network segments using the network monitoring device.

16. The method of claim 1 wherein the determining the connectivity status comprises transferring one or more marker packets to the at least one wireless device over the wireless medium using one or more of the sniffer devices.

17. The method of claim 1 wherein the determining the connectivity status comprises comparing a first identity information with a second identity information, the first identity information being associated with one or more packet transmissions on the wireless medium detected using one or more of the sniffers, the second identity information being associated with at least a subset of computer systems connected to the selected network segments, the second identity information being collected using the network monitoring device.

18. The method of claim 1 wherein one or more of the sniffers interact with one or more wired portions of one or more of the multiple network segments.

19. A network monitoring process module for monitoring a plurality of network segments in a local area network within a selected geographical region, the network monitoring process module being directed to at least determining connectivity status of wireless access devices to the network segments, the network monitoring process module comprising one or more computer readable memories, the one or more computer readable memories comprising:
one or more codes directed to generating one or more marker packets for a selected plurality of network segments in a local area network; and
one or more codes directed to transferring the one or more marker packets to wired portion of the selected network segments.

20. The system of claim 19 wherein the network monitoring process module is provided within a network monitoring device, the network monitoring device being connected into a port on a switch, a router or a gateway device in the local area network, the port being coupled to the wired portion of the selected network segments.

21. The system of claim 19 wherein the network monitoring process module is provided within a switch, a router or a gateway device in the local area network.

22. The system of claim 19 further comprising one or more codes directed to receiving configuration information comprising identity information associated with the selected plurality of network segments.

23. The system of claim 22 wherein the identity information comprises VLAN identifiers of the network segments.

24. The system of claim 22 wherein the identity information comprises IP addresses of the network segments.

25. The system of claim 19 wherein marker packets associated with a network segment have a format, the format corresponds to identity of the network segment.

26. The system of claim 19 further comprising one or more codes directed to receiving one or more packets from the selected plurality of network segments and processing information associated with the packets to determine identity information associated with the network segments.

27. A network monitoring process module for monitoring a plurality of network segments in a local area network within a selected geographic region, the network monitoring process module being directed to at least determining connectivity status of wireless access devices to the network segments, the network monitoring process module comprising one or more computer readable memories, the one or more computer readable memories comprising:
one or more codes directed to receiving one or more packets from wired portion of a selected plurality of network segments in a local area network; and
one or more codes directed to processing information associated with the one or more packets to identify one or more selected format in the one or more packets.

28. The system of claim 27 wherein the network monitoring process module is provided within a network monitoring device, the network monitoring device being connected into a port on a switch, a router or a gateway device in the local area network, the port being coupled to the wired portion of the selected network segments.

29. The system of claim 27 wherein the network monitoring process module is provided within a switch, a router or a gateway device in the local area network.

30. The system of claim 27 wherein the selected format comprises a selected IP multicast destination address.

31. The system of claim 27 wherein the selected format comprises identity information associated with a wireless access device, the wireless access device being coupled to at least one of the selected network segments.

32. The system of claim 31 wherein the identity information associated with the wireless access device is provided in packets by originator of the packets.

33. The system of claim 31 wherein the identity information comprises at least one of SSID (service set identifier) and a wireless side MAC address of the wireless access device.

34. The system of claim 27 further comprising one or more codes directed to transferring information associated with the one or more packets to a server device over one or more computer networks.

35. A network monitoring process module for monitoring a plurality of network segments in a local area network within a selected geographical region, the network monitoring process module being directed to at least determining connectivity status of wireless access devices to the network segments, the network monitoring process module comprising one or more computer readable memories, the one or more computer readable memories comprising:
one or more codes directed to receiving one or more packets from wired portion of a selected plurality of network segments in a local area network; and
one or more codes directed to processing information associated with the one or more packets to derive identity information associated with at least a subset of computer systems coupled to the selected network segments.

36. The system of claim 35 wherein the network monitoring process module is provided within a network monitoring device, the network monitoring device being connected into a port on a switch, a router or a gateway device in the local area network, the port being coupled to the wired portion of the selected network segments.

37. The system of claim 35 wherein the network monitoring process module is provided within a switch, a router or a gateway device in the local area network.

38. The system of claim 35 wherein an identity information associated with a computer system comprises a MAC address of the computer system.

39. The system of claim 35 wherein the one or more packets comprise ARP (address resolution protocol) packets.

40. The system of claim 35 further comprising one or more codes directed to transferring one or more ARP (address resolution protocol) request packets to the selected network segments.

41. The system of claim 35 further comprising one or more codes directed to transferring the derived identity information to a server device over one or more computer networks.
